(19) United States
(12) Patent Application Publication
(10) Pub. No.: US 2005/0015026 A1
(43) Pub. Date: Jan. 20, 2005

(54) Controlled chest compressor

(76) Inventors: Max Harry Well, Rancho Mirage, CA (US); Joe Bisera, Camarillo, CA (US); Clayton Young, Palm Springs, CA (US); Carlost Castillo, Palm Springs, CA (US)

Correspondence Address: LEON D. ROSEN;FREILICH, HORNBAKER & ROSEN, Suite 1220, 10960 Wilshire Blvd., Los Angeles, CA, 90024, US

(21) Appl. No.: 10/620,481

(22) Filed: Jul. 16, 2003

(51) Int. Cl. A61H 31/00

(52) U.S. Cl. 601/44

(57) ABSTRACT

Apparatus for repeatedly compressing the chest of a patient to stimulate blood circulation and breathing, includes an energizable actuator (16) that repeatedly presses against the patient's chest, a torso wrap (32) that wraps to the back of the patient, and a stabilizer (130) that minimizes tilt of the actuator. The stabilizer is generally in the form of an inflatable toroid, or foam toroid, which extends substantially completely around the actuator to prevent tilting in any direction. The actuator includes a reciprocating member (14) that is not only moved down to compress the chest, but that is also pushed up to allow the chest to rise more rapidly. A pressing member (68) at the bottom of the reciprocating member, can tilt. The means for cycling includes compressed breathing gas for cyclically pushing down the reciprocating member, the actuator exhaust being delivered to the patient for breathing. Chest compression and chest recovery, respectively occupy under 30%, and over 70% of the duration of each cycle.

### BACKGROUND OF THE INVENTION

Many persons who suddenly become unconscious can be revived by applying chest compressions to stimulate blood circulation and breathing. Shocks applied by defibrillators can sometimes shock the heart into beating again. Chest compressions applied by hand are helpful, but are generally not as effective, or as reliably applied for long periods of time, as chest compressions applied cyclically by an automatic device. An automatic device can continue chest compressions while defibrillator shocks are applied and while the patient is loaded onto a stretcher and carried to an ambulance, and enables continued chest compressions while the patient travels in the ambulance even when other patients are in the ambulance who require the attention of a rescuer.

Ambulances are often constructed with a plurality of stretcher holders or bays stacked on one another, to hold a plurality of patients who may be injured in a single disaster. Any apparatus that applies chest compressions should be compact so it does not project more than a short distance above the patient's chest, to allow patients to be stacked in an ambulance.

When compressing the chest of the patient, it is desirable to make deep compressions and to apply the compressions rapidly so long as time is allowed for the patient's chest to move up again so deep compressions can be applied. Of course, the compressions should not be so forceful as to injure the patient. A chest compressor of minimum height, that obtained rapid and efficient chest compressions that continued automatically, would be of value.

### SUMMARY OF THE INVENTION

In accordance with one embodiment of the present invention, an apparatus is provided for automatically repeatedly applying compressions to the chest of a patient to stimulate circulation and breathing, which is compact in height and which produces deep chest compressions that are closely spaced in time without harming the patient, for maximum effect on the patient's circulation and breathing. The apparatus includes an actuator with a reciprocating member and means for cycling the reciprocating member to alternately apply a downward force to the member to compress the patient's chest, and for applying an upward force to the member to tend to raise it. The cyclic upward force on the member reduces or eliminates any load on the chest that opposes raising of the chest towards it's initial position. The means for raising the reciprocating member can include a spring or pressurized gas. The lower end of the reciprocating member can be adhered to the patient's chest, as through contact adhesive or a vacuum device, to actually pull up on the chest.

A stabilizer surrounds the compressor to prevent tilt. The stabilizer can be of foam, or can be an inflatable casing to minimize its stored volume and weight. The exhaust from the compressor can be used to inflate the casing. Breathable gas can be used to drive the compressor and the compressor exhaust can be delivered to the patient for breathing.

Each cycle of chest compression and chest recovery is controlled so full chest compression occupies no more than one-third of each cycle.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an isometric view of an apparatus of the present invention for applying chest compressions to a patient, the apparatus being shown held to a patient who is shown in phantom lines.

FIG. 2 is a sectional view of the actuator of FIG. 1, and showing in phantom lines, the actuator in its fully depressed position.

FIG. 3 is a graph showing movement of the lower end of the reciprocating member with time, using the apparatus of FIG. 2, and also showing, in phantom lines, movement when an upward force is not applied to the reciprocating member.

FIG. 4 is a plan view of the actuator of FIG. 1.

FIG. 5 is a sectional side view of an actuator of a second embodiment of the invention, wherein the actuator comprises a bellows.

FIG. 6 is a sectional side view of a third embodiment of the invention, wherein pressured gas is used to push up the reciprocating member after each chest compression.

FIG. 7 is a sectional view of a fourth embodiment of the invention wherein a pressing member can tilt with respect to a reciprocating member.

### DESCRIPTION OF THE PREFERRED EMBODIMENTS

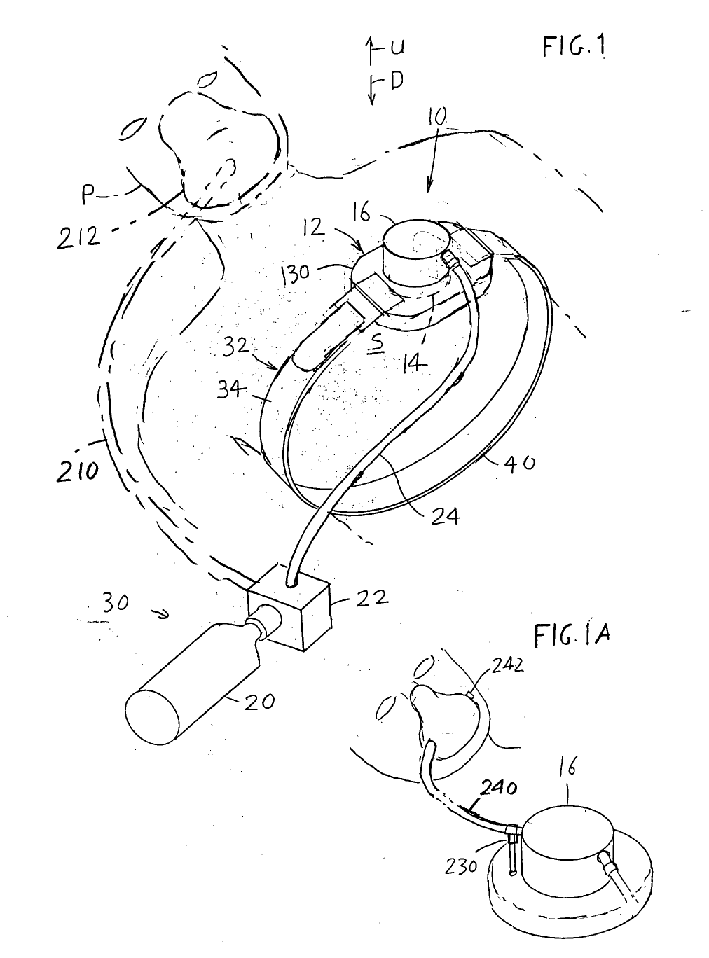

FIG. 1 illustrates a patient P who has dangerously low blood circulation such as might occur in a heart attack. An apparatus 10 of the invention includes a compressor assembly 12 with a reciprocating member 14 having a diameter of about 3 to 4 inches, which can be forcefully pushed down against the sternum S of the patient's chest in a series of regular pulses. The chest compressions stimulate the heart of the patient, which may cause a stopped heart to start again. The compressions also cause some circulation of blood, and also cause some breathing of the patient to supply oxygen to the bloodstream. For an adult male patient, depressing member 14 can press down with a maximum force of about 100 to 120 pounds, in pulses spaced by perhaps ½ to 1 second apart. The period of each cycle is no more than about 1 second (i.e. less than two seconds). This mimics the chest compressions applied manually in CPR (cardiopulmonary resuscitation). For a child, the force is lower. The downward force is always more than 5 pounds during chest compression.

The compressor assembly 12 includes an actuator 16 that forces down the reciprocating member 14 in pulses, a pressure source 20 that supplies pressured gas for energizing the actuator, and a control 22 that regulates the gas pressure and that controls the application of pressured gas to the actuator. The source 20 stores breathable gas, preferably with a higher concentration of oxygen (e.g. up to 100%) than is found in the atmosphere. An elongated flexible tube 24 connects a remote part 30 of the compressor assembly that lies on the ground, to the actuator 16 that lies over the patient's chest.

The apparatus 10 includes a torso wrap 32 which includes a belt or band 34 that extends around the upper torso of the patient. The belt has a back portion 40 that lies at the back of the patient. When the actuator 16 is energized and pushes depressing member 14 in a backward direction which is almost always downward D, the rest of actuator tends to move upward U relative to the patient.

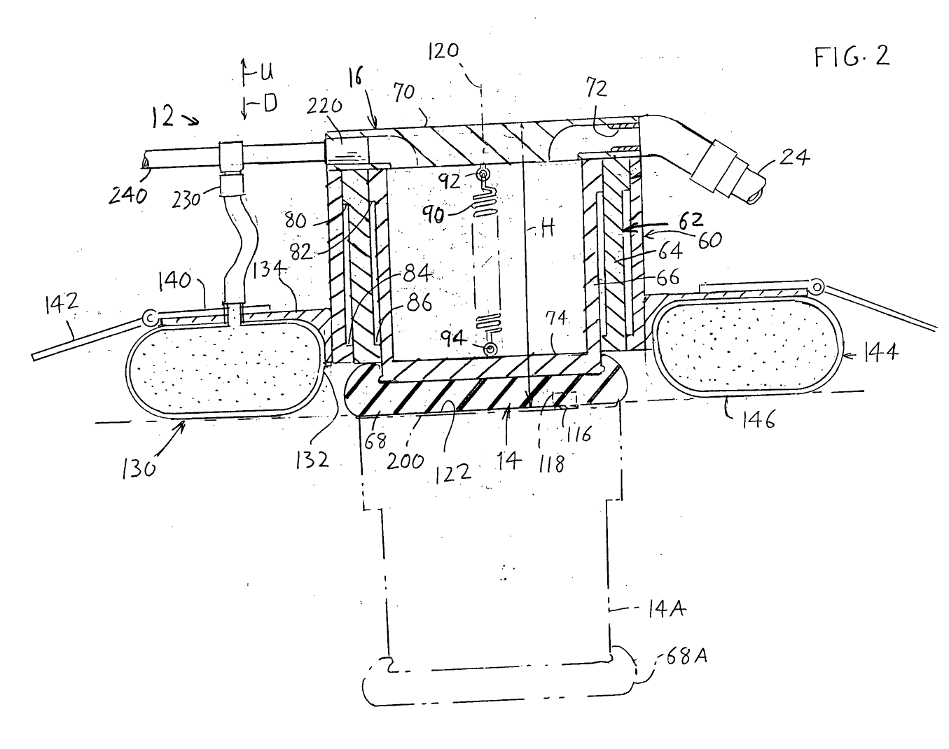

FIG. 2 shows details of the compressor assembly 12, including the actuator 16. The actuator includes a frame or cylinder 60 and a piston assembly or piston 62 lying largely within the cylinder. The particular piston 62 includes two piston parts including upper and lower piston parts 64, 66. A cap 70, which is part of the cylinder, covers the top of the cylinder, and a pressing member 68 that is preferably of elastomeric material is mounted on the bottom of the reciprocating member 14 formed by the lower piston part 66. When pressured air or other gas is supplied through an inlet 72 to the inside of the cylinder, such pressured air presses downward against the lower piston part, especially its large bottom inner surface 74. This compresses the patient's chest. The maximum downward travel of the reciprocating member and pressing part 78 are shown at 14A and 68A. In the downward position, shoulders 80, 82 on the piston parts engage corresponding shoulders 84, 86, one on the cylinder and one on the upper or outer piston part. The inside diameter of the lower piston part 66 is more than half the inside diameter of the cylinder 60, so that a considerable downward force is applied to the patient's chest for a given air pressure in the cylinder.

After each downward thrust of the reciprocating member 14, it is moved up again to its initial position. Previously, this was accomplished by relying on the resilience of a person's chest area. To aid in raising the reciprocating member, applicant includes a means 90 for applying upward forces to the reciprocating member 14 to raise it. The particular means 90 in FIG. 2 is a tension spring with top and bottom ends 92, 94 respectively connected to the cap 70 at the top of the piston, and to the reciprocating member 14 formed by the lower piston part 66. The upward force supplied by the spring 90 counters sliding friction between the piston parts 64, 66 and between the upper piston part 64 and the cylinder 60, as well as countering the weight of the piston parts. This enables more rapid recovery of the chest towards its initial position. The reciprocating member is not coupled to opposite side of the patient's chest so upward movement does not reshape the patient's chest (except that it allows a faster recovery of the chest).

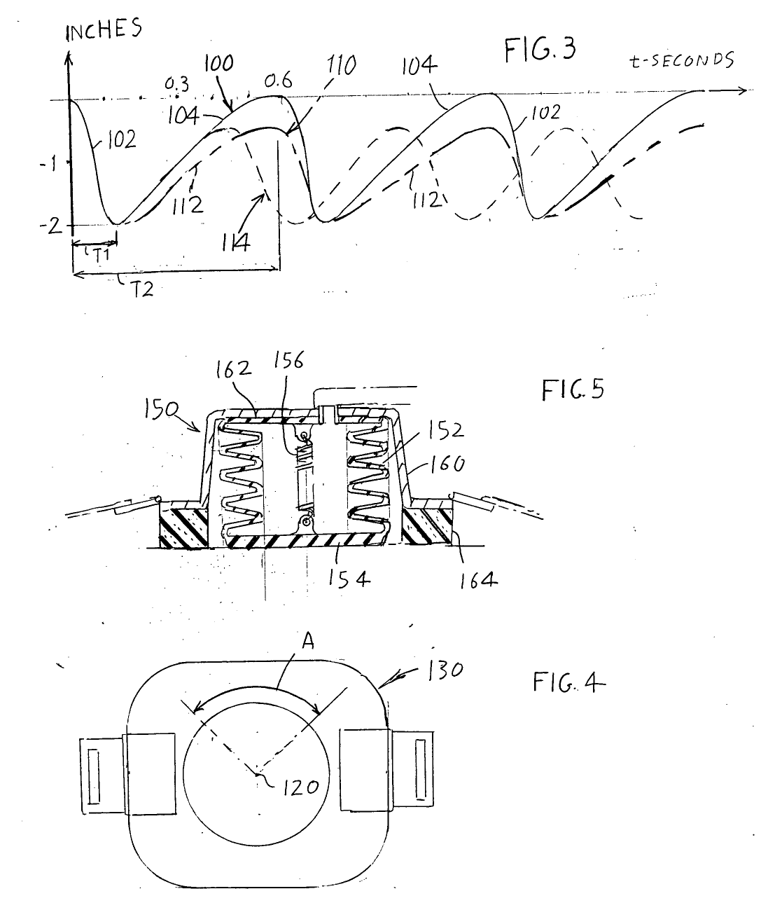

FIG. 3 includes a graph 100 that represents changes in position of the bottom of the reciprocating member with time during cyclic compression of a patient's chest. Graph parts 102 represent the chest compression portion of each cycle, while graph parts 104 represent recovery of the chest, where the compressing device includes the spring or uses air pressure, that lifts the reciprocating member. FIG. 3 includes another graph 110 with graph parts 112 representing recovery of the chest after each compression without assist. If the chest recovery must overcome friction in the piston parts, then a recovery will be somewhat slower without assist. For rapid cycling, which is indicated in FIG. 3 as a compression pulse every 0.6 second, the chest has not fully recovered along the recovery graph parts 112. As a result, each subsequent chest compression will be of smaller depth, such as 1.5 inches instead of two inches, resulting in somewhat less efficacy in heart stimulation, circulation and breathing. An alternative is to leave more time between subsequent chest compressions for the chest to recover, but this also results in reduced efficacy.

FIG. 3 also includes a graph 114 representing recovery (return to its upward position) aided by a spring that lifts the piston, but with a shorter cycle time of about 0.5 second and less chest recovery in each cycle. Tests show that the time periods T1 occupied by chest compressions, such as at 102 in FIG. 3, should be no more than one third (33⅓%) of each cycle. The chest compressions preferably occupy 10% to 30% of each cycle of duration T2, of chest compression followed by chest expansion.

To assure that the chest has recovered sufficiently before the next downward stroke, a detectable member 116 (FIG. 2) is attached to the patient's chest, and a proximity sensor 118 is mounted on the cylinder, as on the pressing member. The output of the sensor is delivered (through electrical wires) to the control 22.

The actuator 16 of FIG. 2 has a vertical axis 120 that should be maintained within about 5° from a vertical direction when the patient's chest location 122 that is being compressed lies in a horizontal plane. To prevent large tilt of the actuator, applicant provides a stabilizer 130. The stabilizer has a central hole 132 that receives the actuator, a top plate 134 on which are mounted fittings 140, 142 for attaching the belt, and an inflatable casing 144. The stabilizer is fixed to the cylinder 60 so the cylinder cannot move up and down, to minimize the weight and height of the compressor assembly. When the means 90 for applying an upward force to the reciprocating member 14 raises the pressing part 68 flush with or above the level of the bottom 146 of the inflated casing, the bottom of the stabilizer presses against the patient.

As shown in FIG. 4, the stabilizer 130 extends completely around the axis 120 of the actuator 16. This avoids more than slight tilting of the actuator in any direction, that is, about any horizontal axis relative to the patient (assuming the patient's chest is horizontal). It would be possible to have small openings in the stabilizer, but a continuous opening should not exceed an angle A of 90° about the axis 120. Any continuous opening preferably does not exceed 75°, and more preferably does not exceed 60°. Otherwise, the actuator 16 can tilt considerably, and cause trauma to the patient, as when a force of 100 to 120 pounds is applied at only one edge of the actuator.

The use of an inflatable stabilizer 130 has the advantage that the stabilizer has low weight, and takes up little volume when it is stored. Rescue workers generally have little spare space and are already loaded with heavy equipment, so minimizing weight and space is highly desirable.

Applicant prefers to use the exhaust gas from the compressor 16 (FIG. 2) to perform as many functions as possible that require substantial power or gas pressure. The exhaust gas which exits through an outlet valve 220, is connected through a pressure limiter 230 to the inflatable stabilizer. When the compressor assembly first begins operating, the rescue worker can manually hold it upright. After perhaps two or three strokes, the stabilizer is inflated.

FIG. 1 shows that part of the breathable gas in the pressure source 20 can be directed through a conduit or tube 210 to the patient mask to supply breathable gas to the patient's respiratory system. In FIG. 1A, applicant shows the exhaust gas from the compressor 16 being directed through a tube 240 to the patient mask. The gas passes through the mask and through a constriction 242 to the atmosphere. This better utilizes the compressed breathable gas from a pressure source. The mask can be placed on the patient a short time after the compressor starts operating.

FIG. 5 illustrates another apparatus 150 for compressing the chest of a patient. Instead of using a piston or telescoping pistons, the apparatus 150 includes an actuator 152 in the form of a bellows, with a reciprocating member 154. A tension spring 156 serves as a means for enhancing cycling by applying an upward force to the reciprocating member 154. However, it is possible to rely solely on the tendency of the bellows to return to its initial configuration. A metal frame 160 attaches an upper end 162 of the bellows to a stabilizer 164.

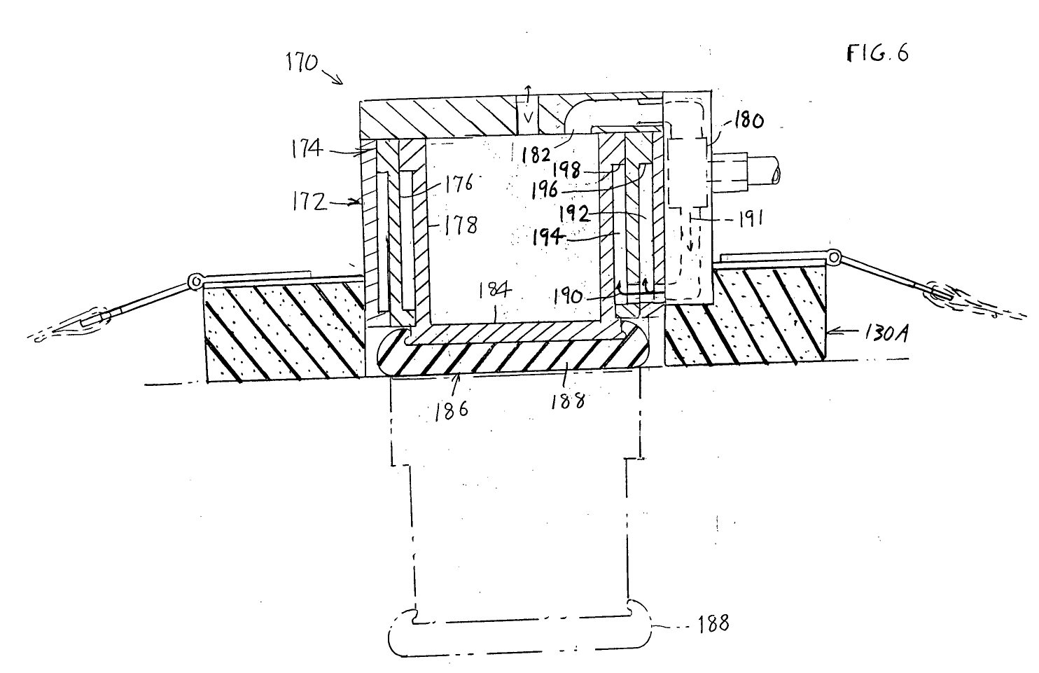

FIG. 6 illustrates another compressor apparatus 170 of a type that includes a cylinder 172 and a piston 174 in the form of inner and outer or upper and lower piston parts 176, 178. A pressure air valve 180 first applies pressured air at an outlet 182 leading to the lower surface 184 of the lower piston part 178 to depress a reciprocating member 186 and an elastomeric pressing member 188 attached to the reciprocating member.

When the pressing member 188 lies near its lowermost position, the valve 180 applies pressured air, as indicated by arrows 190, to spaces 192, 194 to push upward against surfaces 196, 198 to push up the piston parts. Such upward forces on the piston parts enable more rapid cycling, or cycling at a given rate that results in greater chest recovery in each cycle for greater depths of compression. The valve 180 can be electrically controlled by a controller such as 22 in FIG. 1. Advantages of applying pressured gas to raise the piston, are that a considerable upward force (e.g. 5 to 10 pounds) can be applied for rapid chest recovery, it is possible to vary the upward force (e.g. by controlling valve 180 to apply pressured gas more or less rapidly along path 191), and a spring force does not have to be overcome in depressing the piston.

Instead of applying pressure pulses along arrows 190 to raise the piston parts, it would be possible to apply vacuum pulses at the inlet 182 after each pressure pulse. However, a vacuum source is likely to add substantial weight to the system. In FIG. 6, the stabilizer 130A is formed of foam, and preferably of resilient foam. Although the foam does not reduce stored volume, as does an inflatable stabilizer, the foam is light in weight.

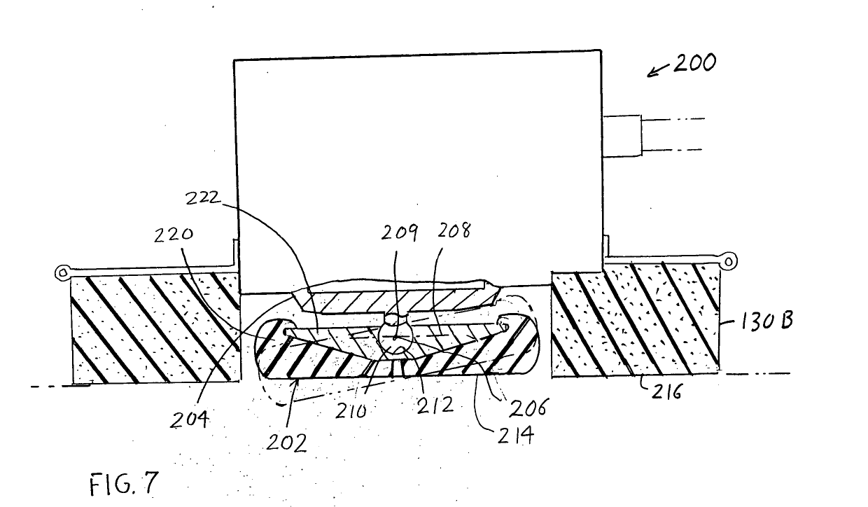

FIG. 7 illustrates another compressor apparatus 200 similar to that of FIG. 6, but wherein a pressing member 202 can tilt with respect to a reciprocating member 204 that is driven up and down. The pressing member can tilt about any horizontal axis passing through a centerpoint 206. That is, the pressing member can tilt about two perpendicular horizontal axes 208 and 209. Such tilt avoids a situation where only one side of the pressing member presses against the chest, which can harm the chest.

Applicant provides a ball 210 and socket 212 connection that allows tilt of a plurality of degrees and preferably at least 5°. A cardan joint can be used instead. The particular apparatus allows tilt of a chest-engaging lower surface 214 of the pressing member by up to 10° from the initial position in which the lower surface is parallel to the surface 216 of the stabilizer 130B. The pressing member includes an elastomeric layer 220 under a metal member 222.

In FIG. 2, applicant has indicated, in phantom lines, a layer of contact adhesive 200 which can be applied to the pressing member 68. The contact adhesive can be pressed against the patient's chest to apply an upward force to the patient's chest. However, care must be taken that not too great an upward force is applied, or else it could injure the patient's skin. Any upward force does not reshape the patient's chest, but only allows a more rapid recovery (lifting) of the chest.

The actuators illustrated in FIGS. 2 and 6, which each have telescoping piston parts, are provided to minimize the height H (FIG. 2) of the compressor assembly 12. Some ambulances can be converted to a multi-patient configuration, wherein patients can be vertically stacked in the ambulance, so that a greater number of patients can be transported in the event of a disaster that produces multiple patients. Such stacking allows only a small vertical separation between patients. Any chest compressing assembly must have a small height in order to fit in the space allocated to each patient. Where a piston is used to compress the chest of a patient, the provision of a telescoping piston arrangement reduces the height and allows the apparatus to be used where limited vertical space is allowed.

The pressure source 20 in FIG. 1 can be a bottle of pressured oxygen. The control can be used to direct low pressure oxygen through a tube 210 leading to face mask 212. The pressure of the oxygen is used to power the chest compressing actuator 16. As discussed above and shown in FIG. 1A, the actuator 16 can be used to reduce the pressure of oxygen and to use the oxygen as a supply to the face mask or elsewhere to the patient's respiratory system (e.g. a tube extending into the mouth or nose). In FIG. 2, an outlet valve 220 is provided, which is sensitive to the flow of pressured gas through inlet 72, to open when the inflow stops. The upward movement of the piston expels reduced-pressure oxygen, which can be flowed to the face mask.

Thus, the invention provides apparatus for applying compressions to the chest of a patient to stimulate breathing and blood circulation, which includes an energizable actuator that repeatedly presses against the patient's chest area. The apparatus includes a stabilizer that lies around the actuator. The stabilizer is generally in the form of a toroid, which includes a portion that extends largely around the actuator and that has a central hole through which the actuator extends. The stabilizer is preferably formed of a pressured gas-filled casing or of resilient foam to avoid tilt in a lightweight stabilizer. It is preferable that there be no gap larger than 90° in the stabilizer, to avoid tipping of the actuator. The pressing member which actually engages the chest (or a sheet on the chest) preferably can tilt a plurality of degrees with respect to the reciprocating member. The actuator includes a reciprocating member and means for cycling the member by alternately applying a downward force to the member and then applying an upward force to it to raise it. The cycles are controlled so chest compression no more than 30% of the time of each cycle. The means for applying an upward force can include a tension spring lying in a cylinder or bellows, an arrangement for applying pressured air to raise a piston, or a plurality of compression springs spaced around a piston or bellows. Pressured breathable (ordinary air or oxygen-rich) gas is used to move the reciprocating member, and the exhaust is directed to the patient for breathing.

Although particular embodiments of the invention have been described and illustrated herein, it is recognized that modifications and variations may readily occur to those skilled in the art, and consequently, it is intended that the claims be interpreted to cover such modifications and equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. Apparatus for applying compressions to the chest of a patient to at least stimulate blood circulation, which includes an energizable actuator that repeatedly presses down against the patient's chest area when the patient's chest faces upward, and a torso wrap that is coupled to said actuator and that wraps to the back of the patient, said actuator including a stationary frame, a reciprocating member, and means for cycling said reciprocating member relative to said frame to repeatedly press said reciprocating member down toward the patient's chest during a part of each cycle, wherein:
said reciprocating member includes a cylinder forming said stationary frame and at least two piston parts that telescope one into the other including an outer piston part that is slideable in said cylinder, and an inner piston part that is slideable in said outer piston part;
said outer piston part being slideable downward in said cylinder to a position wherein a lower end of said outer piston part lies below a lower end of said cylinder, and said inner piston part being slideable downward in said outer piston part to a position wherein a lower end of said inner piston part lies below a lower end of said outer piston part, to thereby minimize the height of the actuator;
said means for cycling said reciprocating member urging both of said piston parts downward during a part of each cycle when said reciprocating member is pressed down.

34. The apparatus described in claim 33 wherein said means for cycling includes a source of pressurized gas connected to said cylinder, and wherein:
said inner piston part has an inside diameter at least half the inside diameter of said outer piston part.

35. The apparatus described in claim 33 including:
means for sensing recovery of the patient's chest, for automatically controlling the instant in each cycle at which said means for cycling begins to again move said reciprocating member to depress the patient's chest.

36. The apparatus described in claim 33 wherein said cylinder has an axis that is primarily vertical when the patient's chest faces upward, and including:
a single pressing member lying on said axis and pivotally connected to a lower end of said piston to enable said pressing member to pivot about horizontal axes, said pressing member having a lower surface for pressing against the patient's chest.

37. The apparatus described in claim 33 wherein said actuator has an axis that is primarily vertical, and including:
a stabilizer connected to said cylinder, said stabilizer extending completely around said actuator without a gap of more than 90° as measured about said axis.

38. Apparatus for repeatedly pressing down against a patient's chest when the chest faces upwardly, including a cylinder, a piston that is moveable in said cylinder, and a source of pressured gas that repeatedly applies pressured gas to said cylinder to move said piston down against the patient's chest, wherein:
said piston includes a plurality of telescoping piston parts including a first piston part with a fitting portion that fits closely to said cylinder and is moveable downward to a lowest position wherein a lower end of said first piston part lies below said cylinder, and a second piston part with a fitting portion that fits closely to said first piston part and that is moveable downward to a position wherein a lower end of said second piston part lies below said lower end of said first piston part in said lowest position of said first piston part.

39. The apparatus described in claim 38 wherein:
said fitting portion of said second piston part has a diameter that is at least one-half the diameter of said fitting portion of said first piston part.

40. The apparatus described in claim 38 wherein said cylinder has a primarily vertical axis, and including:
a pressing member that is connected to a lower end of said second piston part in a pivot joint that allows said pressing member to pivot about horizontal axes that all pass through said primarily vertical axis.

41. A method for applying pressure pulses to a patient's chest, by repeatedly automatically energizing an actuator to apply downward forces to cyclically depress the patient's chest and to cyclically not depress the chest to allow the chest to recover by moving up, comprising:
controlling said actuator to apply downward forces during a period that lasts between 10% and 30% of each cycle, and allowing chest recovery during at least 70% of each cycle.

42. The method described in claim 41 wherein:
said downward forces are applied to produce largely sinusoidal downward movement of the actuator.

43. The method described in claim 41 wherein:
said step of energizing an actuator includes flowing compressed breathable gas to the actuator, and including flowing some of the gas that has passed into the actuator, to the patient for breathing by the patient.

44. The method described in claim 41 including:
allowing a lower end of said actuator that presses against the patient's chest to tilt a plurality of degrees about two perpendicular horizontal axes with respect to the rest of said actuator.

45. The method described in claim 41 including:
applying upward forces to said actuator between applications of downward forces thereto.
